(19) United States
(12) Patent Application Publication
(10) Pub. No.: US 2012/0181108 A1
(43) Pub. Date: Jul. 19, 2012

(54) CEILING AND FREESTANDING ANCHOR FOR EVACUATION

(76) Inventors: Alexis FOREMAN, Boulder, CO (US); Jeffrey Kent ALDRED, Boulder, CO (US); James E. FAY, Boulder, CO (US)

(21) Appl. No.: 13/235,050

(22) Filed: Sep. 16, 2011

Related U.S. Application Data
(60) Provisional application No. 61/383,369, filed on Sep. 16, 2010.
(60) Provisional application No. 61/407,321, filed on Oct. 27, 2010.

(51) Int. Cl. A62B 1/06

(52) U.S. Cl. 182/5

(57) ABSTRACT

A system for overhead anchor evacuation according to embodiments of the present invention includes a support bar configured to extend overhead of a user, a device mount in sliding engagement with the support bar, the device mount slideable along the support bar between a first position in which the device mount is on an inside of an edge of a building, and a second position in which the device mount is on an outside of the edge of the building, wherein the device mount slides freely between the first and second positions during the user's normal use of the system, and a controlled descent device coupled to the device mount.

### CROSS-REFERENCE TO RELATED APPLICATION

This application claims the benefit of U.S. Provisional Patent Application Ser. No. 61/383,369, filed on Sep. 16, 2010, and of U.S. Provisional Patent Application Ser. No. 61/407,321, filed on Oct. 27, 2010, both of which are incorporated by reference herein in their entireties for all purposes.

### TECHNICAL FIELD

Embodiments of the present invention relate generally to evacuation mechanisms, and more specifically to systems and methods for cantilevered ceiling and freestanding anchor systems.

### BACKGROUND

People who seek to evacuate from a building or other structure by rope, for example through a window or over a roof edge, must often tie off the end of the rope to an existing building fixture. Such people often have difficulty finding a proper fixture to which a rope may be securely attached, and such fixtures may not be adequately safe for such uses. Also, because such fixtures are typically on walls or floors or otherwise within reach of the evacuee, the evacuee must often back over a window sill or over a roof edge, thereby running their rope over the window sill or roof edge, which risks damage to the rope.

### SUMMARY

A system for overhead anchor evacuation according to embodiments of the present invention includes a support bar configured to extend overhead of a user, a device mount in sliding engagement with the support bar, the device mount slideable along the support bar between a first position in which the device mount is on an inside of an edge of a building, and a second position in which the device mount is on an outside of the edge of the building, wherein the device mount slides freely between the first and second positions during the user's normal use of the system, and a controlled descent device coupled to the device mount.

According to some embodiments, the support bar is mounted on a freestanding framework, and the freestanding framework includes at least four legs configured to rest on the inside of the edge of the building. In some cases, the freestanding framework includes a first frame section comprising two of the at least four legs, the two of the at least four legs meeting at a first angle, the freestanding framework further comprising a second frame section comprising another two of the at least four legs, the other two of the at least four legs meeting at a second angle, such that the support bar is mounted under the first and second angles. The first frame section may include a cap member with a locking mechanism configured to lock the two of the at least four legs meeting at the first angle against movement with respect to each other. According to some embodiments of the present invention, the at least four legs are adjustable in length. A bottom end of each of the at least four legs may include rollers to permit the freestanding framework to be rolled.

According to embodiments of the present invention, the support bar is extendable and retractable. The support bar may be extendable and retractable between a retracted position in which an end of the support bar is on the inside of the edge, and an extended position in which the end of the support bar is on the outside of the edge.

According to embodiments of the present invention, the support bar is mounted on a ceiling framework. The ceiling framework may include at least one ceiling support member pivotably coupled to the ceiling at a first pivot point and pivotably coupled to the support bar at a second pivot point. In some cases, the ceiling framework and the support bar are configured to fold up for concealment above a ceiling panel in a stowed configuration, and are configured to be extended for operation in a deployed configuration. The support bar includes a first portion and a second portion, and the at least one ceiling support member may be pivotably coupled to the first portion at the second pivot point, such that the device mount is in sliding engagement with the second portion, and the second portion is extendable and retractable with respect to the first portion.

According to embodiments of the present invention, the at least one ceiling support member is substantially vertical in the deployed configuration. Two, four, and/or six ceiling support members may be pivotably coupled to the ceiling and the support bar, for example with equal numbers of ceiling support members on each side of the support bar, according to embodiments of the present invention. The edge may be a roof edge, or a window sill, for example.

Another system for overhead anchor evacuation according to embodiments of the present invention includes a support bar configured to extend overhead of a user, a device mount in sliding engagement with the support bar, the device mount slideable along the support bar between a first position in which the device mount is on an inside of an edge of a building, and a second position in which the device mount is on an outside of the edge of the building, such that the device mount slides freely between the first and second positions during the user's normal use of the system, and such that the support bar is extendable and retractable. In some cases, the support bar is extendable and retractable between a retracted position in which an end of the support bar is on the inside of the edge, and an extended position in which the end of the support bar is on the outside of the edge.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a side perspective view of a ceiling mounted evacuation anchor, according to embodiments of the present invention.

FIG. 2 illustrates the ceiling mounted evacuation anchor of FIG. 1, with the ceiling support members in a partially deployed configuration, according to embodiments of the present invention.

FIG. 3 illustrates the ceiling mounted evacuation anchor of FIG. 2, with the ceiling support members in a fully deployed configuration, according to embodiments of the present invention.

FIG. 4 illustrates the ceiling mounted evacuation anchor of FIG. 3, with the evacuation support bar in an extended configuration, according to embodiments of the present invention.

FIG. 5 illustrates the ceiling mounted evacuation anchor of FIG. 4, with the slider in a fully extended configuration, according to embodiments of the present invention.

FIG. 6 illustrates a freestanding evacuation anchor system, according to embodiments of the present invention.

FIG. 7 illustrates a perspective view of the freestanding evacuation anchor system of FIG. 6, according to embodiments of the present invention.

FIG. 8 illustrates an enlarged perspective view of a cap member joint of FIG. 7, according to embodiments of the present invention.

FIG. 9 illustrates an enlarged perspective view of a cantilever beam end and device mount, according to embodiments of the present invention.

FIG. 10 illustrates additional views of a frame section of the freestanding evacuation anchor system of FIGS. 6 and 7, in both deployed and folded/retracted configurations.

FIG. 11 illustrates a side and end view of a ceiling compression beam, according to embodiments of the present invention.

FIG. 12 illustrates additional views of a frame section of the freestanding evacuation anchor system of FIGS. 6 and 7, in both deployed and folded/retracted configurations.

FIG. 13 illustrates assembly of extendable leg structures, according to embodiments of the present invention.

FIG. 14 illustrates a support bar of the freestanding anchor evacuation system of FIGS. 6 and 7, according to embodiments of the present invention.

FIG. 15 illustrates a pair of lower sections of legs for the freestanding anchor evacuation system of FIGS. 6 and 7, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

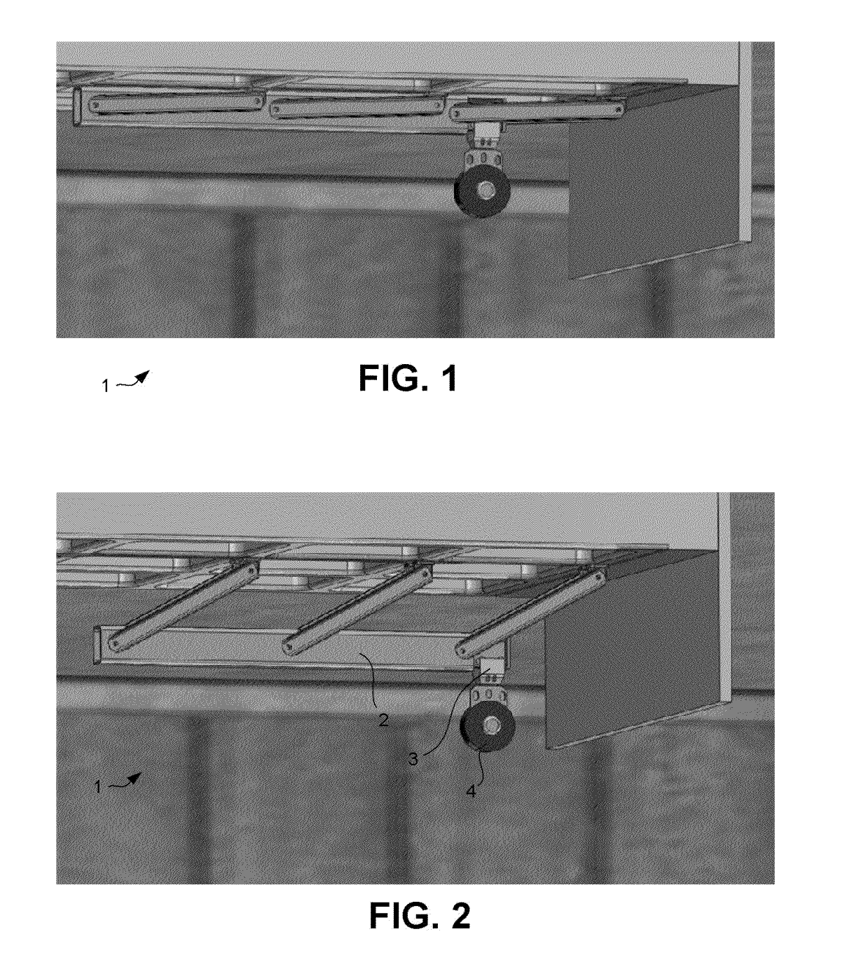

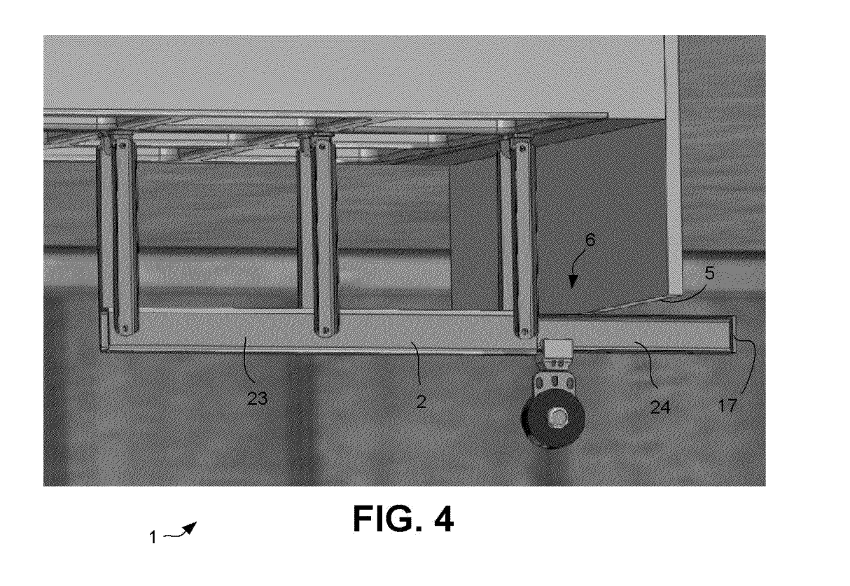

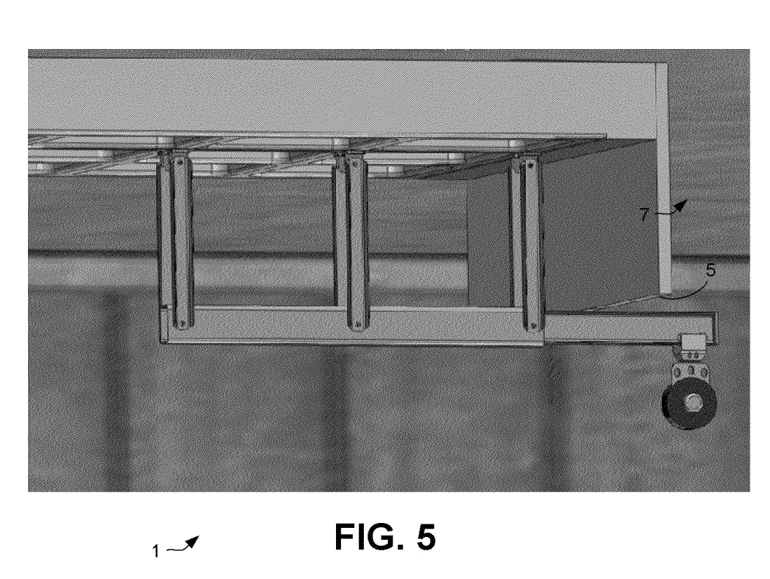

FIGS. 1-6 illustrate an overhead anchor evacuation system 1, 30, according to embodiments of the present invention. A system for overhead anchor evacuation 1 according to embodiments of the present invention includes a support bar 2 configured to extend overhead of a user, a device mount 3 in sliding engagement with the support bar 2, the device mount 3 slideable along the support bar 2 between a first position in which the device mount 3 is on an inside 6 of an edge 5 of a building (as illustrated in FIG. 4), and a second position in which the device mount 3 is on an outside 7 of the edge 5 of the building (as illustrated in FIG. 5). The device mount 3 slides freely between the first and second positions during the user's normal use of the system 1. Such a system 1 may further include a controlled descent device 4 coupled to the device mount 3. The controlled descent device 4 may be a controlled descent device the same as or similar to those described in Patent Cooperation Treaty Application No. PCT/US2010/020268, filed on Jan. 6, 2010, and published as WO 2010/080842 on Jul. 15, 2010, which is incorporated by reference herein in its entirety for all purposes. According to some embodiments of the present invention, the controlled descent device 4 is a DEUS 3000-series or DEUS-7000 series controlled descent device, available from DEUS Rescue of Boulder, Colo. According to some embodiments of the present invention, the device mount 3 is capable of coupling with multiple different devices, which may be switched out even during evacuation to accommodate different people or groups of people being evacuated.

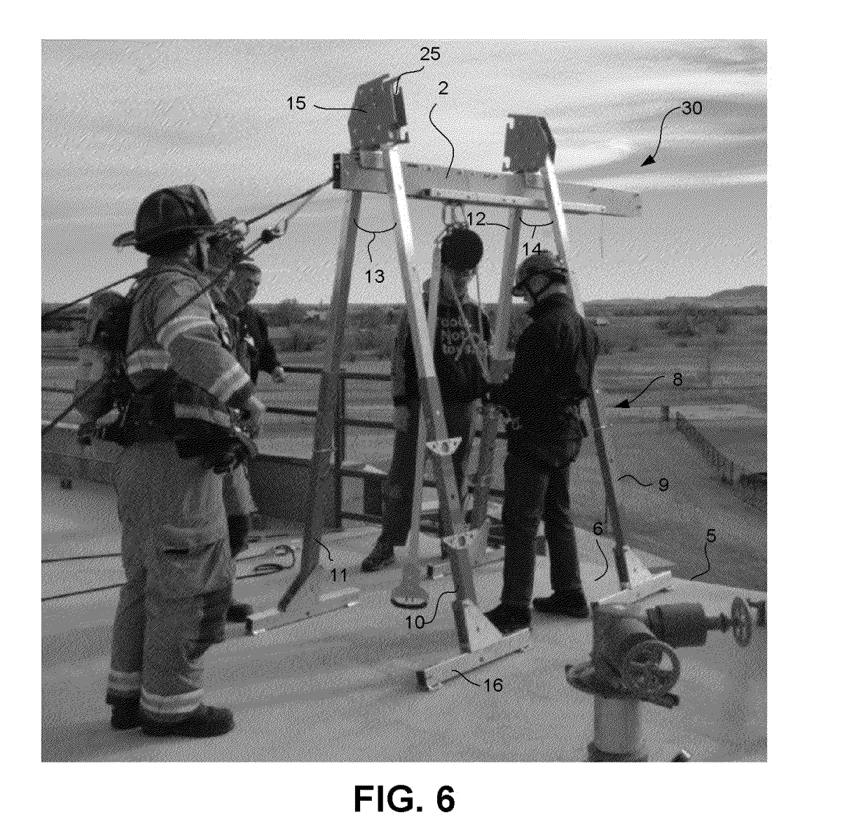

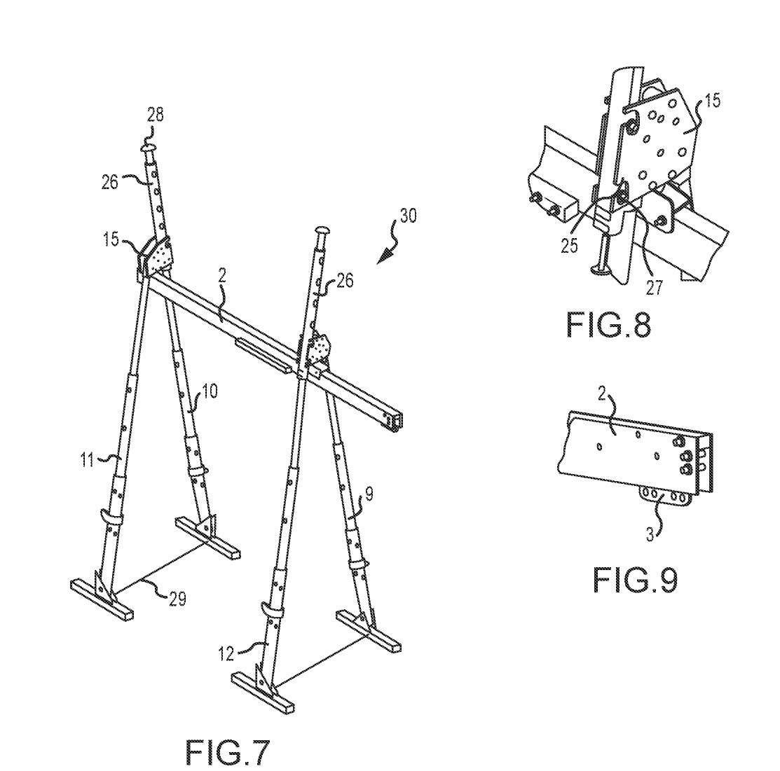

According to some embodiments, the support bar 2 is mounted on a freestanding framework 8, and the freestanding framework 8 includes at least four legs 9, 10, 11, 12 configured to rest on the inside 6 of the edge 5 of the building (as illustrated in FIG. 6). In some cases, the freestanding framework 8 includes a first frame section comprising two 10, 11 of the at least four legs, the two of the at least four legs meeting at a first angle 13, the freestanding framework 8 further including a second frame section comprising another two 9, 12 of the at least four legs, the other two of the at least four legs meeting at a second angle 14, such that the support bar 2 is mounted under the first and second angles 13, 14. The first frame section may include a cap member 15 with a locking mechanism configured to lock the two 10, 11 of the at least four legs meeting at the first angle 13 against movement with respect to each other. A chain or span or strap 29 (see FIG. 7) may also be placed between the two legs 10, 11, for example at or toward the bottom of those legs 10, 11, in order to further prevent the legs 10, 11 from horizontal movement and/or collapse, according to embodiments of the present invention. According to some embodiments of the present invention, the at least four legs 9, 10, 11, 12 are adjustable in length. A bottom end of each of the at least four legs may include rollers 16 to permit the freestanding framework to be rolled.

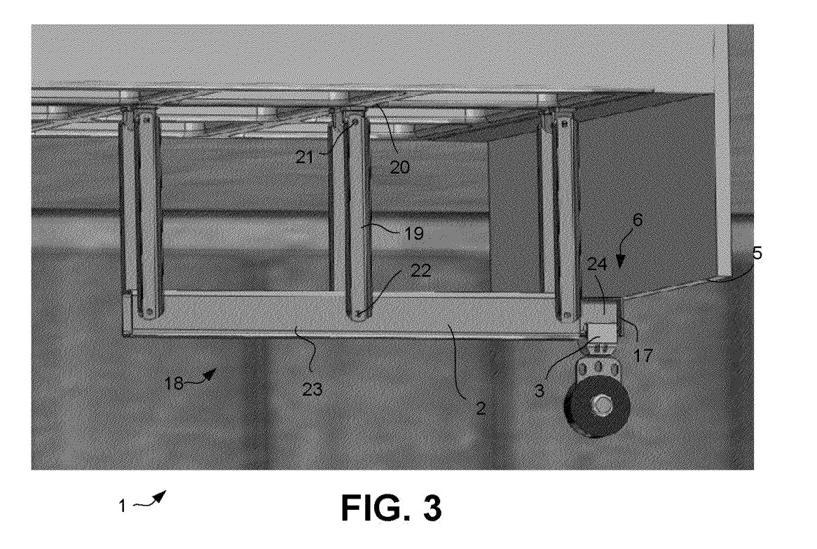

According to embodiments of the present invention, the support bar 2 is extendable and retractable. The support bar 2 may be extendable and retractable between a retracted position in which an end 17 of the support bar 2 is on the inside 6 of the edge 5 (as shown in FIG. 3), and an extended position in which the end 17 of the support bar 2 is on the outside 7 of the edge 5, according to embodiments of the present invention.

According to embodiments of the present invention, the support bar 2 is mounted on a ceiling framework 18. The ceiling framework 18 may include at least one ceiling support member 19 pivotably coupled to the ceiling 20 at a first pivot point 21 and pivotably coupled to the support bar 2 at a second pivot point 22. In some cases, the ceiling framework 18 and the support bar 2 are configured to fold up for concealment above a ceiling panel in a stowed configuration (as shown in FIG. 1), and are configured to be extended for operation in a deployed configuration (as shown in FIGS. 3-5. The support bar 2 includes a first portion 23 and a second portion 24, and the at least one ceiling support member 19 may be pivotably coupled to the first portion 23 at the second pivot point 22, such that the device mount 3 is in sliding engagement with the second portion 24, and the second portion 24 is extendable and retractable with respect to the first portion 23, according to embodiments of the present invention.

According to embodiments of the present invention, the at least one ceiling support member 19 is substantially vertical in the deployed configuration (as illustrated in FIG. 3). Two, four, and/or six ceiling support members may be pivotably coupled to the ceiling and the support bar, for example with equal numbers of ceiling support members on each side of the support bar, according to embodiments of the present invention. The edge may be a roof edge (e.g. FIG. 6), or a window sill (e.g. FIGS. 1-5), for example.

Another system 1, 30 for overhead anchor evacuation according to embodiments of the present invention includes a support bar 2 configured to extend overhead of a user, a device mount 3 in sliding engagement with the support bar 2, the device mount 3 slideable along the support bar 2 between a first position in which the device mount 3 is on an inside 6 of an edge 5 of a building (as illustrated in FIG. 4), and a second position in which the device mount 3 is on an outside 7 of the edge 5 of the building (as illustrated in FIG. 5). The device mount 3 slides freely between the first and second positions during the user's normal use of the system 1, and the support bar 2 is extendable and retractable. In some cases, the support bar is extendable and retractable between a retracted position in which an end 17 of the support bar 2 is on the inside 6 of the edge 5 (as shown in FIG. 3), and an extended position in which the end 17 of the support bar 2 is on the outside 7 of the edge 5, according to embodiments of the present invention.

During an evacuation that requires sending people out through a window on a rope to ground, there may be several needs. For example, such evacuations often call for a method to anchor a controlled descent device so that the ropes descend as near to vertically as possible from the device and not over rough or sharp edges. One way to do this is to suspend the controlled descent device so that it is outside the building and away from the building by a short distance. According to some embodiments of the present invention, a minimum of about six inches away from the building suffices, and it may not be necessary that the distance is more than about three feet. In fact, it may not be beneficial that the distance exceeds about three feet, because in such case the person may risk getting too easily get caught by wind and spun around.

Such evacuations also often call for a quick and reliable anchor system, as well as rigging of hardware done inside the building so that people are not placed in a position where they could accidentally fall during rigging. Rigging (e.g. connecting a person's harness to the controlled descent device 4) performed inside the building also permits three-hundred sixty-degree access to the person while rigging, to reduce fear and eliminate shock loading of the system 1, 30. Embodiments of the present invention include a fast way to rig a person for descent and then to commence the descent.

An anchor system 1, 30 according to embodiments of the present invention may include one or more of the following features and/or characteristics:
Multiple points of attachment to the ceiling to create safety through redundancy
Storage in the ceiling and then deployment when needed, or storage elsewhere with quick-connect couplers and/or bolts for rapid attachment to the ceiling when needed. The system 1 may be fully and permanently attached to the ceiling 20 and ready for deployment.
Storage in a substantially flat configuration against the ceiling and then a folding down for use. The folding down process may be performed mechanically with gravity providing an assist, and/or may be assisted with gas or pneumatic cylinders.
A cantilever beam that extends from the anchor system to a point outside the building. This beam may extend outside the building either by a telescoping action or folding action or bolt-on-bolt action. The extension may be performed by an unfolding action and then a locking action to secure the cantilevered arm in place.
A mechanism to slide the controlled descent device along the beam so that it may be moved from inside to outside and back, repeatedly. all from within the building. This may mean that the descent device is secured to the beam with rollers on a beam (e.g. on an I-shaped beam) or pulleys on a cable and in which the descent device or the moveable attachment system for the descent device will be connected to ropes, cables, or a gear system that allows its travel to be controlled from within the building.

According to some embodiments of the present invention, the evacuation anchor kit is stored in the ceiling and permanently attached to the ceiling so that additional anchoring in a time of emergency is unnecessary. The evacuation anchor kit according to embodiments of the present invention deploys quickly and smoothly. The cantilever arm extends the device outside and away from the skin of the building so that both rope and the person descending are away from rough and dangerous surfaces on the skin of the building, according to embodiments of the present invention. The controlled descent device may be quickly, easily and reversibly moved from inside the building to outside, back and forth, as each person is evacuated. This allows people to connect to the rope or cable of the controlled descent device inside the building, lift their feet, and then be moved to a position outside the building to begin descent.

According to some embodiments of the present invention, the following steps may be used to deploy the system 1, according to embodiments of the present invention:
Remove window.
Remove any ceiling tiles as necessary.
Pull an emergency deployment pin. The system 1 glides into extension position on air cylinders and clicks into place.
Gantry beam is extended into place with a hand crank or a chain fall and locked.
Evacuee is rigged, inside the building, for descent.
Evacuee is moved into descent position by a rope pulley system from inside.
Evacuee descents.
After descent, the controlled descent device 4 is pulled back into the building for safe rigging of the next evacuee.

FIG. 1 shows the system 1 fully stowed behind a drop ceiling. FIG. 2 shows system 1 in mid-deployment, in which the pins release system, and gas cylinders (not shown) ensure smooth engagement. FIG. 3 illustrates full deployment of system 1, in which system 1 is ready for beam to be extended and trolley system to be extended via a hand crank (not shown). FIG. 4 illustrates the beam fully extended to ensure a safe descent down the face of the building. According to some embodiments, the end 17 is eighteen inches beyond edge 5. The device 4 is still within the building for rigging of the evacuee. FIG. 5 illustrates system 1 as being ready for descent. A pulley system (or other system) moves the trolley out to full extension with the evacuee rigged and hanging. This prevents a “pendulum”-type leap or “leap of faith” from the window sill, according to embodiments of the present invention.

With system 30, getting people out and down during evacuation is faster, easier and safer than with alternative methods. It works in a wide variety of locations (whether inside a building or on the roof of the building or otherwise) and solves the major challenges of evacuation and rescue. The kit 30 is a complete, engineered anchor platform for high rescue. It sets up anywhere in less than four minutes. It provides a rock-solid overhead anchor with a three foot cantilever over the side of a building or out a window, and a sliding trolley inside the overhead beam that vastly simplifies over-the-edge transition. It is designed to make rescuing multiple people fast and efficient to save lives.

Setting evacuation anchors in commercial buildings or industrial structures presents five serious challenges:
1. Secure anchorage points are not where you need them. Many commercial and industrial structures do not have installed anchors for emergency evacuation. That means setting up someplace else, working with compromised safety or stretching a long anchor from something substantial to where you need to evacuate.
2. Setting up a secure anchor can take time. It can take precious minutes to stretch a safe and secure anchor from something substantial to where you need to evacuate. If the building is on fire, time is critical.
3. Overhead anchors may not be available and overhead anchors have huge advantages over low anchors. During transition, low anchors induce shock-load that cause injuries and slow the process when many people have to be evacuated. A slow process means that somebody may not get out. Overhead anchors minimize shock load and speed the transition process.
4. An “inside” anchor can damage rope and injure the people being evacuated. When the controlled descent device is anchored inside the building, the rope used for controlled descent will, by necessity, drag over a sharp edge. This can also cause the person descending to drag against the side of the building during descent. This slows evacuation and may mean the rope wears out before the last person has been evacuated.
5. Transition is difficult and slow for untrained people. Even with an overhead anchor, transition is a daunting task hundreds of feet up in the air. Getting an untrained person to step over the edge is a slow and difficult process.

According to some embodiments of the present invention, the kit 30 has one or more of the following features and/or characteristics:
1. The system 30 sets up anywhere, without a need to connect to anything. It may be set up where the ceiling is too high or between floors where the ceiling is low. It can be tied off, compression-fit between floor and ceiling, and/or or counterbalanced.
2. The system 30 sets up in four minutes. The entire setup process—unpacking bags, clicking parts together, and positioning for use—can be done by two people in four minutes.
3. The system 30 provides a secure overhead anchor to minimize transition problems and shock load. The double A-frame design with overhead beam can support any evacuation or rescue.
4. The system 30 is a cantilever design. The three foot cantilever over the edge or out the window of a building protects both the rope and the person descending from dragging over sharp edges and building obstructions.
5. The system 30 has an integrated trolley that improves transition dramatically. With the trolley, the evacuee may be rigged inside the building, then glided easily out of the building to begin descent.

The system 30 is designed to assist in the evacuation of many people from commercial buildings or industrial structures. It sets up quickly and easily, anywhere. It is freestanding, rock solid, and the innovative overhead cantilever beam with sliding trolley vastly simplifies over-the edge transition and prevents rope damage.
The system 30 is an engineered anchor that is certified to meet the ANSI standard with a SWL (Safe Working Load) to support two people (600 lbs). The system also meets the EN fall-arrest standard for two people.
The system 30 is a stable double A-frame design with a ten foot custom aluminum extrusion-profile connecting beam.
The parts of the system 30 slide together and lock in place with custom double quick-locks. Everything is then further locked in position with retaining pins that are connected to the frame to prevent loss.
The telescoping legs of the system 30 allow anchor height to be adjusted from a minimum of 45 inches to a maximum of 113 inches, according to embodiments of the present invention. Overall frame height is 66 inches to 134 inches, according to embodiments of the present invention.
The system 30 includes two multi-position compression beams that fit into anchors on top of each of the two A-frames. These compression beams can be quickly adjusted to compress the entire anchor kit between floor and ceiling for added stability. The compression beams are opposed at a 20° angle for cross-load stability and work for floor to-ceiling heights of 68″ to 177″. The kit can be further stabilized (both counter-balance and lateral) with four Quik-Connect Anchor Kits, available from DEUS Rescue of Boulder, Colo. And, alternatively, two big people standing on the rear legs provide ample hold-down force for safe evacuation.
The system 30 stores in three black Cordura® nylon bags with full length zippers for easy access. Bags are 60″×12″×12″. Both bags and parts are labeled for easy identification and assembly by two trained people in under four minutes. The bags store easily on-site. Loaded bags weigh about 60 lbs each and are easy to carry by one or two people, according to embodiments of the present invention.

System 30 makes transitioning a person to move from solid ground to suspension on a rescue rope much easier. When positioned at the edge of a building, the ten foot connecting beam in the system 30 cantilevers over the edge of the building by three feet. The cantilever protects rope and people from sharp edges, speeds transition and eliminates excessive rope friction that hinders descent or lifting. The trolley 3 inside the ten foot connecting beam rolls the entire length of the beam on four redundant wheels, according to embodiments of the present invention. The trolley is larger than the exit-profile in the beam as a redundant back-up to prevent failure. In order to transition with the system 30, the trolley 3 is pulled inside, the person is connected to a controlled descent device attached to the trolley, the trolley is pushed outside and over the building edge, and then the person descends unobstructed, according to embodiments of the present invention.

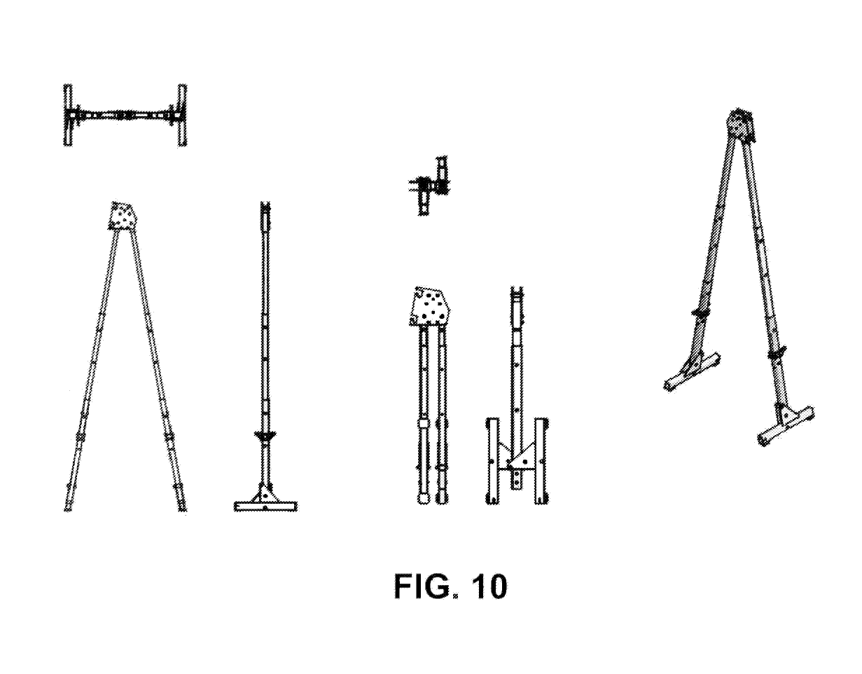

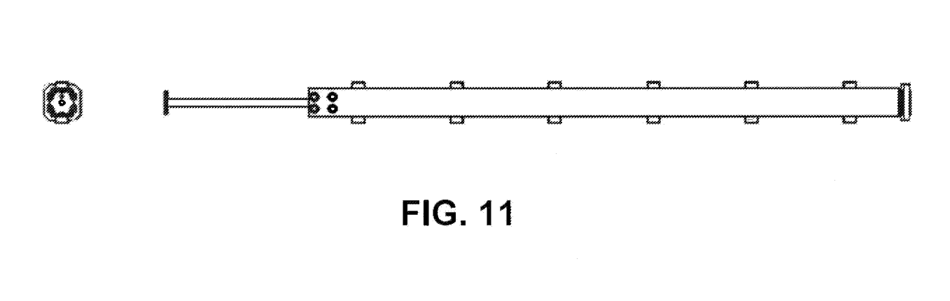

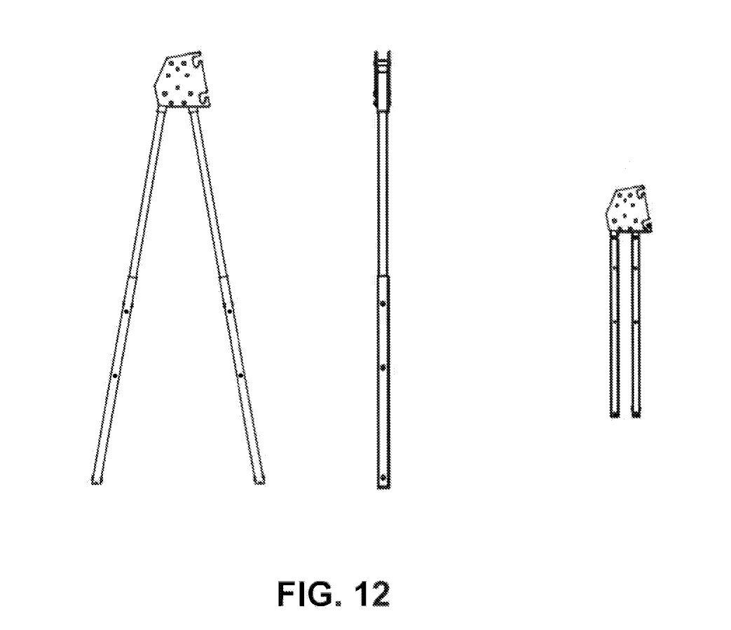

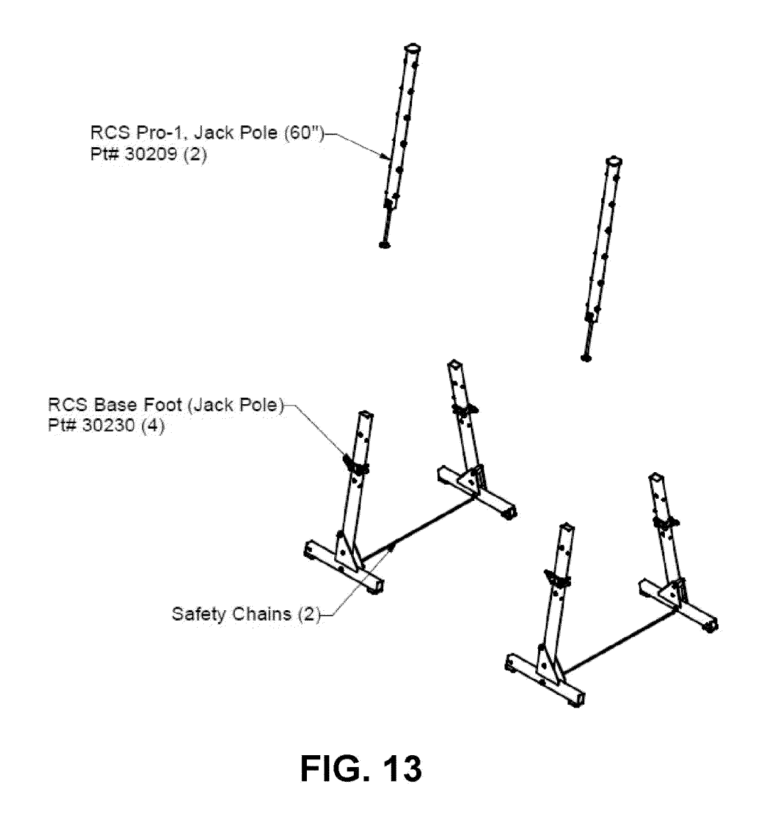

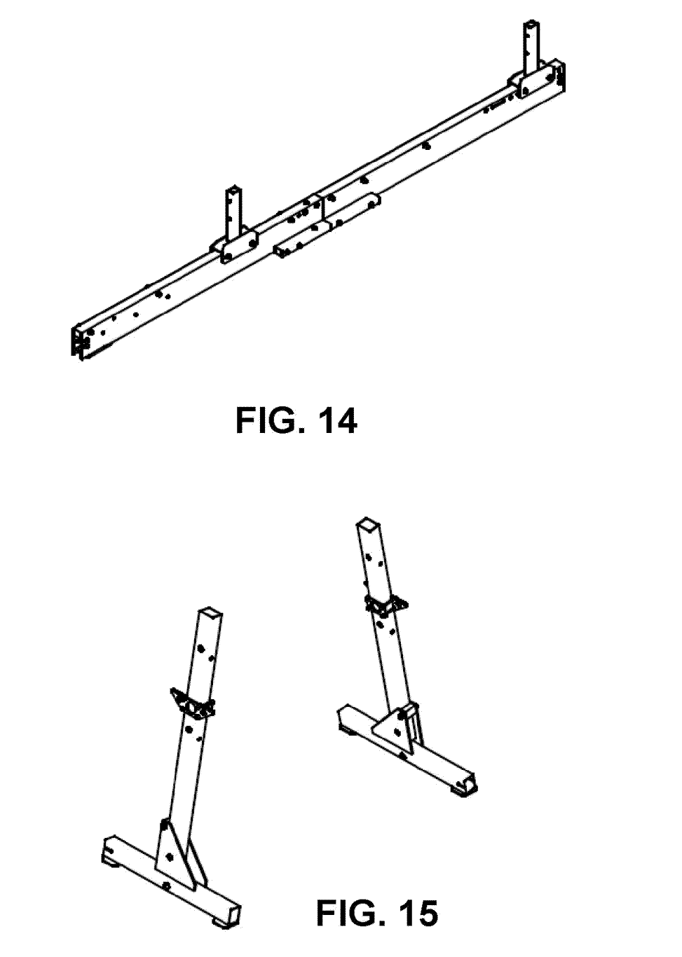

FIGS. 7-10 illustrates system 30 with ceiling compression beams 26, according to embodiments of the present invention. When used in a room or inside a building, the ceiling compression beams 26 may be added to the caps 15 in order to permit enhanced stabilization of the framework 8, according to embodiments of the present invention. The ceiling compression beams 26 may have one or more protrusions 27 configured to slide into or engage with one or more notches 25 on the caps 15 to secure the ceiling compression beams 26 to the caps 15, according to embodiments of the present invention. The converse arrangement may also be used, in which the cap 15 has a protrusion which fits within a notch on the beam 26. The length of the beams 26 may be adjusted, such that end 28 of beam 26 is pushed up against the ceiling of the room, while the legs 9, 10, 11, 12 push against the floor of the room. The ceiling beams 26 may be lengthened and tightened until the desired compression is achieved.

The beams 26 are in-line with the legs 10, 12 of their respective “A-frame” frame 8 sections, one on each side. The ceiling compression beams push up to the ceiling. According to some embodiments of the present invention, these beams actually push at angles to the ceiling, and opposing angles. The result is that the opposing ceiling compression beams pushing at angles to the ceiling create more lateral stability for the entire anchor than if they just pushed straight up, according to embodiments of the present invention.

As described herein, systems 1, 30 may be used to evacuate people by lowering them. However, systems 1, 30 may also be used to lift people, for example rescue personnel. To do this, a pulley may be mounted to the rolling trolley and a rigid push-bar may also be connected to the trolley. Then, a winch may be mounted to the rigid push-bar and the cable may be run from the winch through the pulley connected to the trolley. With this arrangement, the trolley can still be rolled in and out while the winch is used. Such a setup could be used over the edge of a building if it were desired to raise a person from down below rather than lower that person. The system 30 may also be set up or deployed over a pit that has uneven sides—a common problem in rescues—and the trolley allows raising a person from the pit without scraping the person against the sides, according to embodiments of the present invention.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A system for overhead anchor evacuation, the system comprising:
a support bar configured to extend overhead of a user;
a device mount in sliding engagement with the support bar, the device mount slideable along the support bar between a first position in which the device mount is on an inside of an edge of a building, and a second position in which the device mount is on an outside of the edge of the building, wherein the device mount slides freely between the first and second positions during the user's normal use of the system; and
a controlled descent device coupled to the device mount.

2. The system of claim 1, wherein the support bar is mounted on a freestanding framework, wherein the freestanding framework comprises at least four legs configured to rest on the inside of the edge of the building.

3. The system of claim 2, wherein the freestanding framework comprises a first frame section comprising two of the at least four legs, the two of the at least four legs meeting at a first angle, the freestanding framework further comprising a second frame section comprising another two of the at least four legs, the other two of the at least four legs meeting at a second angle, wherein the support bar is mounted under the first and second angles.

4. The system of claim 3, wherein the first frame section comprises a cap member with a locking mechanism, the locking mechanism configured to lock the two of the at least four legs meeting at the first angle against movement with respect to each other.

5. The system of claim 4, further comprising a ceiling compression bar coupled to the cap member, and configured to extend to engage with a ceiling above the ceiling compression bar, so as to compress the freestanding framework between a floor and the ceiling.

6. The system of claim 2, wherein the at least four legs are adjustable in length.

7. The system of claim 2, wherein a bottom end of each of the at least four legs comprises rollers to permit the freestanding framework to be rolled.

8. The system of claim 1, wherein the support bar is extendable and retractable.

9. The system of claim 8, wherein the support bar is extendable and retractable between a retracted position in which an end of the support bar is on the inside of the edge, and an extended position in which the end of the support bar is on the outside of the edge.

10. The system of claim 1, wherein the support bar is mounted on a ceiling framework.

11. The system of claim 10, wherein the ceiling framework comprises at least one ceiling support member pivotably coupled to the ceiling at a first pivot point and pivotably coupled to the support bar at a second pivot point.

12. The system of claim 11, wherein the ceiling framework and the support bar are configured to fold up for concealment above a ceiling panel in a stowed configuration, and are configured to be extended for operation in a deployed configuration.

13. The system of claim 12, wherein the support bar comprises a first portion and a second portion, wherein the at least one ceiling support member is pivotably coupled to the first portion at the second pivot point, wherein the device mount is in sliding engagement with the second portion, and wherein the second portion is extendable and retractable with respect to the first portion.

14. The system of claim 12, wherein the at least one ceiling support member is substantially vertical in the deployed configuration.

15. The system of claim 12, wherein the at least one ceiling support member is at least two ceiling support members, each pivotably coupled to the ceiling and to the support bar, with one on each side of the support bar.

16. The system of claim 12, wherein the at least one ceiling support member is at least four ceiling support members, each pivotably coupled to the ceiling and to the support bar, with two on each side of the support bar.

17. The system of claim 12, wherein the at least one ceiling support member is at least six ceiling support members, each pivotably coupled to the ceiling and to the support bar, with three on each side of the support bar.

18. The system of claim 1, wherein the edge is a roof edge.

19. The system of claim 1, wherein the edge is a window sill.

20. A system for overhead anchor evacuation, the system comprising:
a support bar configured to extend overhead of a user;
a device mount in sliding engagement with the support bar, the device mount slideable along the support bar between a first position in which the device mount is on an inside of an edge of a building, and a second position in which the device mount is on an outside of the edge of the building, wherein the device mount slides freely between the first and second positions during the user's normal use of the system,
wherein the support bar is extendable and retractable.

21. The system of claim 19, wherein the support bar is extendable and retractable between a retracted position in which an end of the support bar is on the inside of the edge, and an extended position in which the end of the support bar is on the outside of the edge.
